(19) United States
(12) Patent Application Publication
(10) Pub. No.: US 2025/0115369 A1
(43) Pub. Date: Apr. 10, 2025

(54) SMART LIGHTING SYSTEM AND METHOD FOR AVERTING BIRD STRIKES

(71) Applicant: HONEYWELL INTERNATIONAL INC., Charlotte, NC (US)

(72) Inventors: Sivakumar Kanagarajan, Bangalore (IN); Gobinathan Baladhandapani, Madurai (IN)

(73) Assignee: HONEYWELL INTERNATIONAL INC., Charlotte, NC (US)

(21) Appl. No.: 18/530,729

(22) Filed: Dec. 6, 2023

(30) Foreign Application Priority Data
Oct. 10, 2023 (IN) 202311067801

(51) Int. Cl. B64D 45/00; B64D 47/06

(52) U.S. Cl. CPC B64D 45/00; B64D 47/06; B64D 2045/0095

(57) ABSTRACT

An aircraft lighting system includes a light source and a processing system. The light source is rotationally mounted on an external surface of an aircraft to rotate at least 360-degrees about a rotational axis. The light source is configured, upon being electrically energized, to emit light. The processing system is in operable communication with the light source and is coupled to receive an anti-bird mode activation signal and one or more sensor signals representative of a position and flight path of birds. The processing system is configured, upon receipt of the anti-bird mode activation signal, to process the one or more sensor signals to determine the position and flight path of the birds, electrically energize the light source to emit light, and command the light source to rotate in one or more directions so that the emitted light is directed toward birds.

### CROSS-REFERENCE TO RELATED APPLICATION

The present application claims benefit of prior filed India Provisional Patent Application No. 202311067801, filed Oct. 10, 2023, which is hereby incorporated by reference herein in its entirety.

### TECHNICAL FIELD

The present disclosure generally relates to a system and method for preventing bird strikes, and more particularly to a smart lighting system and method for preventing bird strikes and aircraft incorporating the lighting system.

### BACKGROUND

Aircraft may be at risk of a bird strike, especially when operating near coastal areas or “flyways” of bird migration routes. Indeed, according to a report issued by the Federal Aviation Administration (FAA), instances of bird strikes increased six-fold between 1990 and 2012, in which a record 10,343 reported bird strikes occurred.

Bird strikes have been known to cause damage to aircraft, and to result in other deleterious effects. In cases where birds strike the nose or windshield of an aircraft, the entire crew and the passengers may be at risk. Thus, various solutions have been proposed for preventing, or at least inhibiting, aircraft bird strike events.

One solution, which is available at many aerodromes, involves the use of fixed, ground-based, solid-state pulse compression radar. The radar observes the approach and path of birds that may encroach on the airport approach and departure routes, and alert aircraft of the birds. Another solution, which is an airborne solution, also involves active radar systems that may compete with existing weather radar and ILS navigation antennas in the nose of an aircraft. Thus, fully active radar is not financially or logistically viable.

Hence, there is a need for a system and method of preventing, or at least inhibiting, aircraft bird strike events that does not rely on active radar, either on the ground or airborne, and that does not interfere with existing weather radar and ILS navigation antennas. The present disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an aircraft lighting system includes a light source and a processing system. The light source is adapted to be rotationally mounted on an external surface of an aircraft to rotate at least 360-degrees about a rotational axis. The light source is configured, upon being electrically energized, to emit light. The processing system is in operable communication with the light source and is coupled to receive (i) an anti-bird mode activation signal and (ii) one or more sensor signals representative of a position and flight path of one or more birds. The processing system is configured, upon receipt of the anti-bird mode activation signal, to: process the one or more sensor signals to determine the position and flight path of the one or more birds, electrically energize the light source to emit light, and command the light source to rotate in one or more directions so that the emitted light is directed toward the one or more birds.

In another embodiment, a method for averting a bird strike for an aircraft, includes the steps of receiving, in a processing system, one or more sensor signals representative of a position and flight path of one or more birds; receiving, in the processing system, an anti-bird mode activation signal; processing the one or more sensor signals, in the processing system, to determine the position and flight path of the one or more birds; electrically energizing a light source to emit light; and commanding the light source to rotate in one or more directions so that the emitted light is directed toward the one or more birds, wherein the light source is rotationally mounted on an external surface of the aircraft to rotate at least 360-degrees about a rotational axis.

In yet another embodiment, an aircraft system includes an aircraft, a light source, and a processing system. The light source is rotationally mounted on an external surface of the aircraft to rotate at least 360-degrees about a rotational axis. The light source is configured, upon being electrically energized, to emit light. The processing system is disposed within the aircraft and is in operable communication with the light source. The processing system is coupled to receive (i) an anti-bird mode activation signal and (ii) one or more sensor signals representative of a position and flight path of one or more birds. The processing system is configured, upon receipt of the anti-bird mode activation signal, to process the one or more sensor signals to determine the position and flight path of the one or more birds, electrically energize the light source to emit light, and command the light source to rotate in one or more directions so that the emitted light is directed toward the one or more birds.

Furthermore, other desirable features and characteristics of the aircraft lighting system and method for averting a bird strike for an aircraft will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a functional block diagram of one embodiment of an aircraft lighting system; and

FIG. 2 depicts a process, in flowchart form, that may be implemented in the system of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

This disclosure provides an anti-bird mode within the existing lighting system as a smart feature, but with at least some of the exterior lights having 360-degree rotational freedom. Upon activation of the anti-bird mode, and based upon the direction of the approaching bird(s), the angle of one or more exterior lights is changed toward the direction of the bird(s) and light is emitted to avert the bird(s). The anti-bird mode may be automatically or manually triggered.

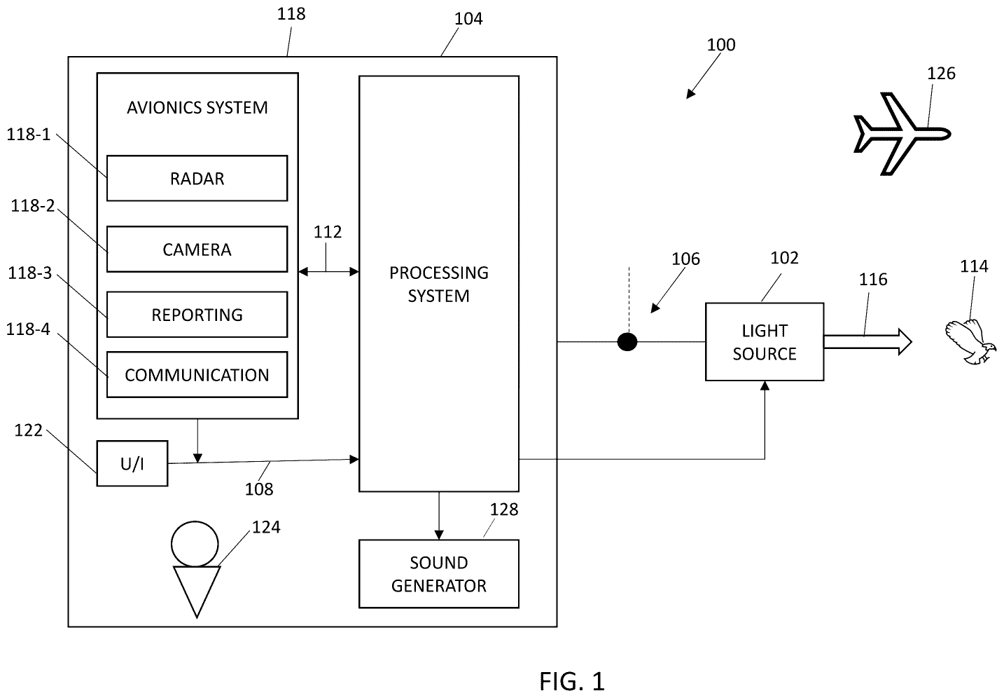

Referring now to FIG. 1, a functional block diagram of one embodiment of an aircraft lighting system 100 is depicted. The aircraft lighting system 100, at least in the depicted embodiment, is disposed on or within an aircraft 110, and includes at least one light source 102 and a processing system 104. The light source 102 is rotationally mounted on an external surface of the aircraft 110 and is configured to rotate at least 360-degrees about a rotational axis 106. The light source 102 is additionally configured, upon being electrically energized, to emit light.

The processing system 104 generally represents the hardware, circuitry, processing logic, and/or other components configured to facilitate operation of the aircraft lighting system 100 and perform additional processes, tasks and/or functions to support operation of the aircraft lighting system 100, as described in greater detail below. Depending on the embodiment, the processing system 104 may be implemented or realized with a general-purpose processor, a controller, a microprocessor, a microcontroller, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein.

In practice, the processing system 104 includes processing logic that may be configured to carry out the functions, techniques, and processing tasks associated with the operation of the aircraft lighting system 100 described in greater detail below. Furthermore, the steps of a method or algorithm described in connection with the embodiments disclosed herein may be embodied directly in hardware, in firmware, in a software module executed by the processing system 104, or in any practical combination thereof. In accordance with one or more embodiments, the processing system 104 includes or otherwise accesses a data storage element, such as a memory (e.g., RAM memory, ROM memory, flash memory, registers, a hard disk, or the like) or another suitable non-transitory short or long term storage media capable of storing computer-executable programming instructions or other data for execution that, when read and executed by the processing system 104, cause the processing system 104 to execute and perform one or more of the processes, tasks, operations, and/or functions described herein.

With the above in mind, it is noted that the processing system 104 is disposed within the aircraft 110 and is in operable communication with the light source 102. The processing system 104 is coupled to receive an anti-bird mode activation signal 108 and one or more sensor signals 112. The one or more sensor signals 112 are representative of the position and flight path of one or more birds 114 (only one depicted). The processing system 104 is configured, upon receipt of the anti-bird mode activation signal 108, to process the one or more sensor signals 112 to determine the position and flight path of the one or more birds 114, to electrically energize the light source 102 to emit light 116, and to command the light source 102 to rotate in one or more directions so that the emitted light 116 is directed toward the one or more birds 114.

It will be appreciated that the anti-bird mode activation signal 108 may be supplied automatically, from one or more avionics systems 118, or manually, from a user interface 122. Whether or not the one or more avionics systems 118 supply the anti-bird mode activation signal 108, the one or more avionics system 118 are configured to at least supply the one or more sensor signals 112. In this regard, and as FIG. 1 further depicts, the one or more avionics systems 118 may include one or more of an onboard radar system 118-1, an onboard camera 118-2, an onboard reporting system 118-3, and/or an onboard communication system 118-4. The onboard reporting system 118-3, when included, may supply the sensor signals 112 based on data from one or more NOTAMs (Notice to Airmen), one or more PIREPs (Pilot Reports), or one or more ATIS (automatic terminal information service) communications, just to name a few. The onboard communication system 118-4, when included, may supply the sensor signal based on information it receives from a ground-based radar system regarding one or more birds.

When the anti-bird mode activation signal 108 is supplied manually, via the user interface 122, it may be done so in response to, for example, the aircraft pilot 124 receiving communications from air traffic control, communications from other aircraft, or from visual sighting of birds by the pilot 124 or other flight crew.

As is generally known, bird aversion may be improved by varying one or more characteristics of the light 116 that is emitted toward the bird(s) 114. Thus, in some embodiments, the processing system 104 is additionally configured to electrically energize the light source 102 to emit the light 116 with one or more variable characteristics. It will be appreciated that the one or more variable characteristics may vary. For example, the variable characteristics may include at least one or more of varying the intensity of the emitted light 116, emitting the light in one or more pulse patterns, and/or varying the color of the emitted light 116.

The processing system 104 may also, in some embodiments, be further configured to selectively generate and supply one or more alert signals. The alert signals, when generated and supplied, may be, for example, transmitted to other aircraft 126. In addition to, or instead of, transmitting the alert signals to other aircraft 126, the processing system 104 may be configured to supply the one or more alert signals to a sound generator 128. The sound generator 128, when included, is in operable communication with the processing system 104 and is configured, upon receiving one or more alert signals, to generate one of more audible sounds that will alert the pilot 124 to the presence of the bird(s) 114.

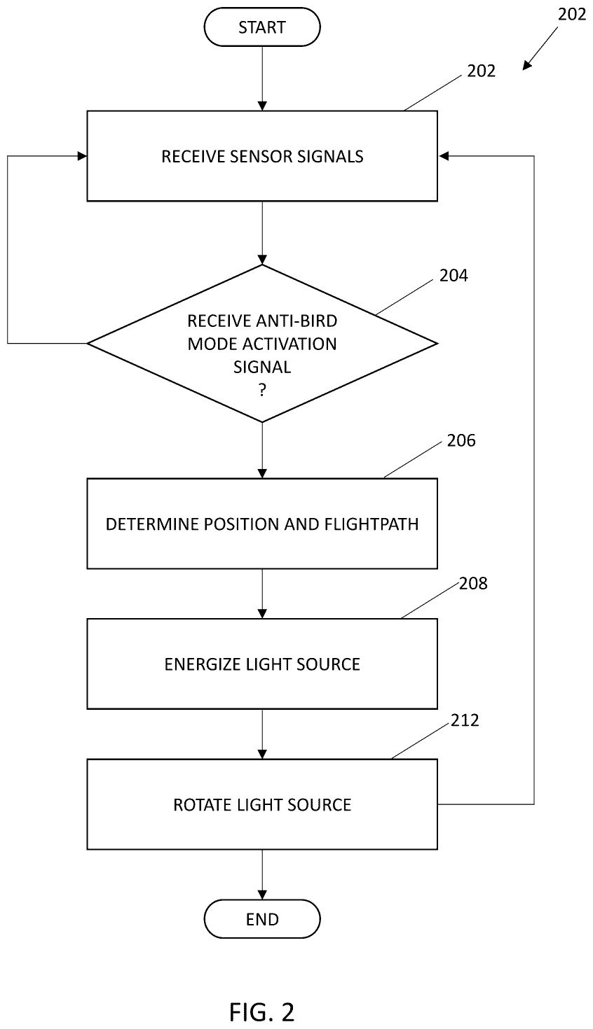

Having described the overall functionality of the aircraft lighting system 100, a description of a method for averting a bird strike that is implemented in aircraft lighting system 100 will now be described. The method 200, which is depicted in flowchart form in FIG. 2, represents various embodiments of a method for averting a bird strike. For illustrative purposes, the following description of method 200 may refer to elements mentioned above in connection with FIG. 1. In practice, portions of method 200 may be performed by different components of the described aircraft lighting system 100. It should be appreciated that method 200 may include any number of additional or alternative tasks, the tasks shown in FIG. 2 need not be performed in the illustrated order, and method 200 may be incorporated into a more comprehensive procedure or method having additional functionality not described in detail herein. Moreover, one or more of the tasks shown in FIG. 2 could be omitted from an embodiment of the method 200 if the intended overall functionality remains intact.

The method 200 starts and the processing system 104 receives the one or more sensor signals 112 representative of the position and flight path of one more birds (202). The processing system 104 also awaits receipt of the anti-bird mode activation signal 108 (204). Then, upon receipt of the anti-bird mode activation signal 108, the processing system 104 processes the one or more sensor signals to determine the position and flight path of the one or more birds (206), electrically energizing the light source 102 to emit light 116 (208), and commands the light source 102 to rotate in one or more directions so that the emitted light is directed toward the one or more birds (212).

The system and method described herein prevent, or at least inhibit, aircraft bird strike events without relying on active radar, either on the ground or airborne, and without any interference with existing weather radar and ILS navigation antennas.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft lighting system, comprising:
a light source adapted to be rotationally mounted on an external surface of an aircraft to rotate at least 360-degrees about a rotational axis, the light source configured, upon being electrically energized, to emit light; and
processing system in operable communication with the light source and coupled to receive (i) an anti-bird mode activation signal and (ii) one or more sensor signals representative of a position and flight path of one or more birds, the processing system configured, upon receipt of the anti-bird mode activation signal, to:
process the one or more sensor signals to determine the position and flight path of the one or more birds;
electrically energize the light source to emit light; and
command the light source to rotate in one or more directions so that the emitted light is directed toward the one or more birds.

2. The system of claim 1, wherein:
the processing system is further configured to electrically energize the light source to emit light with one or more variable characteristics.

3. The system of claim 2, wherein the one or more variable characteristics include at least one or more of intensity, pulse pattern, and color.

4. The system of claim 1, further comprising
one or more avionics systems in operable communication with the processing system and configured to supply the anti-bird mode activation signal and the one or more sensor signals.

5. The system of claim 4, wherein the one or more avionics systems include one or more of an onboard radar system, an onboard camera, an onboard reporting system, and an onboard communication system, wherein the onboard communication system receives information regarding one or more birds from a ground-based system.

6. The system of claim 1, further comprising:
a user interface configured to receive input from a user and, in response to receiving the input from the user, to supply the anti-bird mode activation signal.

7. The system of claim 1, wherein the processing system is further configured to selectively generate and supply one or more alert signals.

8. The system of claim 1, wherein the processing system is further configured to generate and transmit one or more alert signals to other aircraft.

9. The system of claim 1, further comprising:
a sound generator in operable communication with the processing system, the sound generator configured, upon receiving one or more commands, to generate one of more audible sounds,
wherein the processing system is further configured to supply the one or more commands to the sound generator.

10. A method for averting a bird strike for an aircraft, comprising the steps of:
receiving, in a processing system, one or more sensor signals representative of a position and flight path of one or more birds;
receiving, in the processing system, an anti-bird mode activation signal;
processing the one or more sensor signals, in the processing system, to determine the position and flight path of the one or more birds;
electrically energizing a light source to emit light; and
commanding the light source to rotate in one or more directions so that the emitted light is directed toward the one or more birds,
wherein the light source is rotationally mounted on an external surface of the aircraft to rotate at least 360-degrees about a rotational axis.

11. The method of claim 10, further comprising:
electrically energizing the light source to emit light with one or more variable characteristics.

12. The method of claim 11, wherein the one or more variable characteristics include at least one or more of intensity, pulse pattern, and color.

13. The method of claim 10, further comprising
supplying the anti-bird mode activation signal and the one or more sensor signals from one or more avionics systems in operable communication with the processing system.

14. The method of claim 13, wherein the one or more avionics systems include one or more of an onboard radar system, an onboard camera, an onboard reporting system, and an onboard communication system, wherein the onboard communication system receives information regarding one or more birds from a ground-based system.

15. The method of claim 10, further comprising supplying the anti-bird mode activation signal from a user interface that is configured to receive input from a user.

16. The method of claim 10, further comprising selectively generating and supplying one or more alert signals.

17. The method of claim 10, further comprising generating and transmitting one or more alert signals to other aircraft.

18. The method of claim 10, further comprising:
supply one or more commands from the processing system to a sound generator; and
generating, using the sound generator and in response to receiving the one or more commands, one of more audible sounds.

19. An aircraft system, comprising:
an aircraft;
a light source rotationally mounted on an external surface of the aircraft to rotate at least 360-degrees about a rotational axis, the light source configured, upon being electrically energized, to emit light; and
a processing system disposed within the aircraft and in operable communication with the light source, the processing system coupled to receive (i) an anti-bird mode activation signal and (ii) one or more sensor signals representative of a position and flight path of one or more birds, the processing system configured, upon receipt of the anti-bird mode activation signal, to:
process the one or more sensor signals to determine the position and flight path of the one or more birds;
electrically energize the light source to emit light; and
command the light source to rotate in one or more directions so that the emitted light is directed toward the one or more birds.
